(19) United States
(12) Patent Application Publication
(10) Pub. No.: US 2023/0355004 A1
(43) Pub. Date: Nov. 9, 2023

(54) SMART MATTRESS AND CONTROL METHOD THEREOF

(71) Applicant: CARILEX MEDICAL, INC., Taoyuan City (TW)

(72) Inventors: Chih-Peng LO, Taoyuan City (TW); Sheng-Feng YEN, Taoyuan City (TW)

(21) Appl. No.: 17/853,483

(22) Filed: Jun. 29, 2022

(30) Foreign Application Priority Data
May 5, 2022 (TW) 111116634
Jun. 28, 2022 (TW) 111124095

(51) Int. Cl. A47C 27/08; G01L 19/08; G01S 17/08; G05B 15/02

(52) U.S. Cl. CPC A47C 27/083; A47C 27/082; G01L 19/086; G01S 17/08; G05B 15/02

(57) ABSTRACT

A smart mattress includes an airbag unit, a sensing unit, and a control unit. The airbag unit includes a first surface and a second surface arranged opposite to each other. The sensing unit senses a distance data between the first surface and the second surface. When the control unit determines that the distance data is less than a preset distance, the control unit inflates the airbag unit to make the distance data be greater than or equal to the preset distance. The present disclosure further includes a control method for the smart mattress.

### BACKGROUND

### Technical Field

The present disclosure relates to a smart mattress, in particular to a smart mattress with a maintainable inflated state, and a control method of the smart mattress.

### Description of Related Art

Generally, an air mattress supports a human body from a bottom surface of the human body by an inflatable structure therein, so that a user lying on the air mattress may avoid directly touching the ground. Further, in order to adjust an inflation state according to different usage requirements, the air mattress is also equipped with an air pressure pump to inflate the inflatable structure, or even adjust the inflation state (for example, air pressure, etc.) to match different usage requirements.

Most of the methods used to adjust the inflation state in a related art air mattress use a barometer to detect the air pressure in the inflatable structure, or arrange a pressure sensor directly on the upper surface of the air mattress. However, as to the movement of the user on the air mattress, he seldom lies on or leaves the air mattress at one time with his whole-body surface. When the user's body is partially moving, an air pressure sensing method may not correctly know the user's movements on the air mattress, and may fail to correctly recognize the user's movements. In addition, when the air mattress is partially pressed or released, gas molecules in the air mattress need to propagate to a state with a uniform molecular density before conducting pressure sensing, resulting in poor sensitivity and real-time performance of the air pressure sensing method.

Further, since a pressure value measured by the pressure sensor is related to a contact area between the air mattress and the user, it may happen that the user has actually touched the ground (that is, the inflatable structure has been completely exhausted), but the pressure sensor does not sense abnormal conditions. As a result, the user experience for the air mattress is unsatisfactory, and even worse, it is easy to cause problems of bedsores for the user who is difficult to turn over.

Therefore, how to design a smart mattress and a control method thereof is an important subject studied by the inventor of the present disclosure.

### SUMMARY

One object of the present disclosure is to provide a smart mattress, which may instantly sense human movements, has high sensitivity, and may avoid abnormal conditions, so as to improve a user experience and avoid an occurrence of bedsores.

In order to achieve the object of the present disclosure, the smart mattress includes an airbag unit, a sensing unit, and a control unit. The airbag unit includes a first surface and a second surface arranged oppositely. The sensing unit is arranged on the first surface of the airbag unit, and senses a distance data between the first surface and the second surface. The control unit is connected with the airbag unit and the sensing unit, receives the distance data. Further, when the control unit determines that the distance data is less than a preset distance, the control unit inflates the airbag unit, so that the distance data is greater than or equal to the predetermined distance.

In some embodiments, the sensing unit includes an infrared sensor and a gravity sensor. The infrared sensor is electrically connected to the control unit, and senses the distance data. The gravity sensor is electrically connected to the control unit, and generates an angle change data. Further, the control unit outputs a first warning message according to the angle change data.

In some embodiments, the control unit includes an air pressure sensor. The air pressure sensor is connected to the airbag unit, and generates an air pressure data. Further, when the control unit determines that the distance data is less than the preset distance, and the air pressure data is less than a preset air pressure, the control unit inflates the airbag unit, so that the distance data is greater than or equal to the preset distance, and the air pressure data is greater than or equal to the preset air pressure.

In some embodiments, when a change time of the air pressure data is greater than a preset time, the control unit outputs a second warning message.

In some embodiments, the control unit includes a processing element, and a pump element. The processing element is electrically connected to the sensing unit, and outputs a control signal when the distance data is less than the preset distance. The pump element is electrically connected with the processing element, receives the control signal, and outputs a gas.

In some embodiments, the control unit is connected in communication with a cloud unit, and the cloud unit receives the distance data to generate a graphical data.

Another object of the present disclosure is to provide a smart mattress, which may instantly sense human movements with high sensitivity, and may avoid abnormal conditions, so as to improve a user experience and avoid an occurrence of bedsores.

In order to achieve the object of the present disclosure, the smart mattress includes a plurality of airbag units, a plurality of infrared sensors, and a control unit. The plurality of airbag units is arranged in parallel at equal distances, each airbag unit includes an upper surface and a lower surface arranged oppositely. The plurality of infrared sensors is respectively arranged on the lower surfaces of at least a part of the airbag units. The control unit is connected with the airbag units and the infrared sensors. Further, the lower surface of each of the airbag units is a light-transmitting surface.

In some embodiments, the airbag units include a first group of airbag units, a second group of airbag units, and a third group of airbag units. The second group of airbag units are adjacent to the first group of airbag units. The third group of airbag units are adjacent to the second group of airbag units, the second group of airbag units is located between the first group of airbag units and the third group of airbag units. Further, the infrared sensors are respectively arranged on at least one of the airbag units of the first group of airbag units, at least one of the airbag units of the second group of airbag units, and at least one of the airbag units of the third group of airbag units.

In some embodiments, the smart mattress further includes a gravity sensor. The gravity sensor is arranged on the lower surface of at least one of the airbag units, and is electrically connected with the control unit, and generates an angle change data. Further, the control unit outputs a first warning message according to the angle change data.

In some embodiments, the control unit includes an air pressure sensor. The air pressure sensor is connected to the airbag units, and generates an air pressure data. Further, when the control unit determines that the air pressure data is less than a preset air pressure, the control unit inflates the airbag units, so that the air pressure data is greater than or equal to the preset air pressure.

In some embodiments, when a change time of the air pressure data is greater than a preset time, the control unit outputs a second warning message.

In some embodiments, the control unit includes a processing element, and a pump element. The processing element is electrically connected to the sensing unit. The pump element is electrically connected with the processing element, and inflates the airbag units.

In some embodiments, the control unit is connected in communication with a cloud unit, and the cloud unit receives an infrared data from the infrared sensors to generate a graphical data.

More still another object of the present disclosure is to provide a control method for a smart mattress, which may instantly sense human movements with high sensitivity, and may avoid abnormal conditions, so as to improve a user experience and avoid an occurrence of bedsores.

In order to achieve the object of the present disclosure, the control method includes the following step: sensing an upper surface of a smart mattress, calculating a distance data between the upper surface and a lower surface of the smart mattress, determining whether the distance data less than a preset distance, inflating the smart mattress when the distance data less than the preset distance, so that the distance data is greater than or equal to the preset distance.

In some embodiments, the control method further includes the following steps: outputting an infrared signal from the lower surface, receiving the infrared signal reflected from the upper surface by the lower surface. Further, the distance data is obtained by an amount of energy of the infrared signal received.

In some embodiments, the control method further includes the following step: sensing an angle change data of the lower surface. Further, the control unit outputs a first warning message according to the angle change data.

In some embodiments, the control method further includes the following step: sensing an air pressure data of the smart mattress. Further, the control method inflates the smart mattress when the air pressure data is less than a preset air pressure, so that the distance data is greater than or equal to the preset distance, and the air pressure data is greater than or equal to the preset air pressure.

In some embodiments, the control method further includes the following step: outputting a second warning message when a change time of the air pressure data is greater than a preset time.

In some embodiments, the control method further includes the following steps: outputting a control signal when the distance data is less than the preset distance, receiving the control signal, and inflating the smart mattress.

In some embodiments, the control method further includes the following step: receiving the distance data to generate a graphical data.

In summary, the smart mattress of the present disclosure obtains a current inflation state of the airbag unit by sensing the distance between the opposite sides (for example, the upper surface and the lower surface) of the airbag unit. In some embodiments, the sensing unit (for example, infrared sensor) has an ability to output and receive infrared signals. When the sensing unit is arranged on the lower surface, the distance data of the airbag unit is obtained by receiving the infrared signal reflected from the upper surface. At this time, the preset distance that has been pre-stored before the smart mattress is sold. For example, the preset distance is stored in a memory such as ROM in the control unit, independent storage units such as EEPROM, NAND flash, or cloud server, etc., the control unit is used to determine whether the distance data meets a requirement of the preset distance (for example, it needs to be greater than or equal to the preset distance), so as to determine whether to further inflate the airbag unit, or to issue a warning message (such as air leakage or falling out of bed).

In the related-art technology, a barometer is usually used to determine whether to perform an inflation action. However, as to the movement of the user on the air mattress, he seldom lies on or leaves the air mattress at one time with his whole-body surface. When the user's body is partially moving, an air pressure sensing method may not correctly know the user's movements on the air mattress, and may fail to correctly recognize the user's movements. In addition, when the air mattress is partially pressed or released, gas molecules in the air mattress need to propagate to a state with a uniform molecular density before conducting pressure sensing, resulting in poor sensitivity and real-time performance of the air pressure sensing method.

Compared with the related-art technology, in some embodiments of the present disclosure, the control method of distance sensing clearly recognizes that the user's movements on various local positions on the smart mattress are pressing or releasing. The system uses the control method of distance sensing to infer the user's movements or posture, allowing the control unit to accurately inflate some airbag units (for example, individual control of each airbag unit, or differentiation of airbag units in odd and even order, etc.). In addition, the control method of distance sensing of the present disclosure is applied to a change of a distance between the upper surface and the lower surface of the airbag unit, so as to avoid a state where the user has touched the ground but does not sense abnormality.

Therefore, the smart mattress and the control method thereof in the present disclosure, which is instant in sensing human movements, has high sensitivity, and may avoid abnormal conditions, so as to improve a user experience and avoid an occurrence of bedsores.

In order to further understand the techniques, means, and effects of the present disclosure for achieving the intended object. Please refer to the following detailed description and drawings of the present disclosure. The drawings are provided for reference and description only, and are not intended to limit the present disclosure.

### BRIEF DESCRIPTION OF DRAWINGS

FIG. 1 is a system architecture diagram of a first embodiment of a smart mattress of the present disclosure.

FIG. 2 is a schematic structural diagram of a single airbag unit of the smart mattress of the present disclosure.

FIG. 3 is a flow chart of a control method of the first embodiment of the smart mattress of the present disclosure.

FIG. 4 is a system architecture diagram of a second embodiment of the smart mattress of the present disclosure.

FIG. 5 is a schematic structural diagram of a plurality of airbag units of the smart mattress of the present disclosure.

FIG. 6 to FIG. 8 are flowcharts of the control method of the second embodiment of the smart mattress of the present disclosure.

FIG. 9 is a schematic diagram of a graphical data of the smart mattress of the present disclosure.

### DETAILED DESCRIPTION

The following are specific examples to illustrate some implementations of the present disclosure. A person skilled in the art may understand the advantages and effects of the present disclosure from the content disclosed in this specification. The present disclosure may be implemented or applied through other different specific embodiments, and various details in this specification may also be based on different viewpoints and applications, and various modifications and changes may be made without departing from the concept of the present disclosure.

It should be understood that the structures, the proportions, the sizes, the number of components, and the like in the drawings are only used to cope with the contents disclosed in the specification for understanding and reading by those skilled in the art, and it is not intended to limit the conditions that may be implemented in the present disclosure, and thus is not technically significant. Any modification of the structure, the change of the proportional relationship, or the adjustment of the size, should be within the scope of the technical contents disclosed by the present disclosure without affecting the effects and the achievable effects of the present disclosure.

The technical content and detailed description of the present disclosure will be described below in conjunction with the drawings.

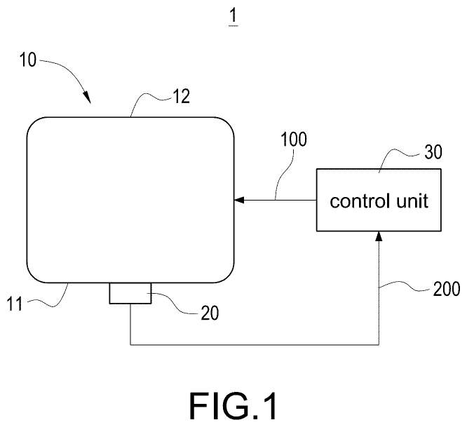

FIG. 1 is a system architecture diagram of a first embodiment of a smart mattress of the present disclosure.

As shown in FIG. 1, the smart mattress 1 includes an airbag unit 10, a sensing unit 20, and a control unit 30.

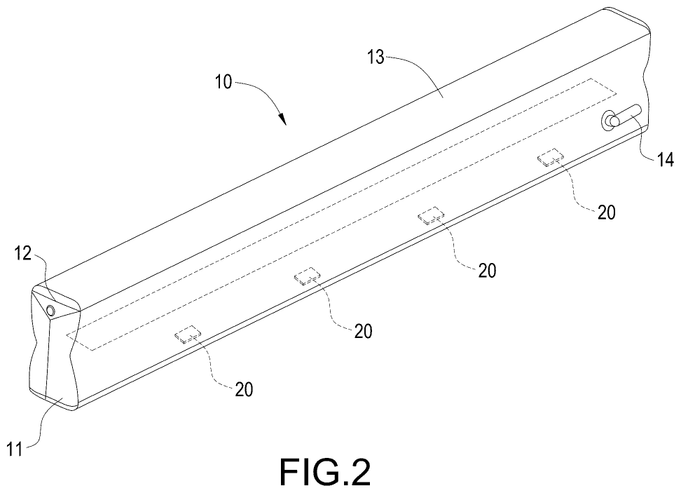

The airbag unit 10 includes a first surface 11 and a second surface 12 opposite to each other. In some embodiments, the first surface 11 is a lower surface of the airbag unit 10, and the second surface 12 is an upper surface of the airbag unit 10. In other embodiment, the second surface 12 is a surface between the actual upper surface (such as the surface 13 shown in FIG. 2) and the lower surface (namely, the first surface 11) of the airbag unit 10 and used for sensing, but there is not limited thereto.

In some embodiments, the airbag unit 10 may be made of plastics. Further, the airbag unit is made by handwork, thermoforming, blow molding, or 3D printing technology. In some embodiments, the type of 3D printing technology includes extrusion type, metal wire type, particle type, powder inkjet needle type, lamination type, or photopolymerization type. Further, the extrusion type may include fused deposition modeling (FDM) and fused filament modeling (FFF). The metal wire type may include electron-beam freeform fabrication (EBF). The particle type may include direct metal laser sintering (DMLS), electron-beam melting (EBM), selective laser melting (SLM), selective heat sintering (SHS), and selective laser sintering (SLS). The powder inkjet needle type may include plaster-based 3D printing (PP). The lamination type may include laminated object manufacturing (LOM). The photopolymerization type may include stereolithography (SLA), digital light processing (DLP), but there is not limited thereto.

In some embodiments, further, the plastics include high-strength high-density plastics as follows: acrylonitrile butadiene styrene (ABS), polyethylene (PE), polypropylene (PP), styrene acrylonitrile resin (SAN resin, also known as AS polyester), Nylon, polycarbonate (PC), polytetrafluoroethylene (PTFE, also known as Teflon), polyethylene terephthalate (PET), polyoxymethylene(POM), polyphenylsulfone (PPSF/PPSU), polylactic acid/polylactide (PLA), polyetherimide (PEI), polymethyl methacrylate (PMMA), polyvinyl chloride (PVC), urea formaldehyde (UF), melamine formaldehyde (MF), etc., but there is not limited thereto.

FIG. 2 is a schematic structural diagram of a single airbag unit of the smart mattress of the present disclosure.

As shown in FIG. 2, it is an embodiment of a single airbag unit 10 (also known as a mattress cell). The lower surface (for example, the first surface 11) of the airbag unit 10 may be arranged with a sensing unit 20 (which may include an infrared sensor and/or a gravity sensor). It is worth mentioning that the other surface relative to the first surface 11 is an arcuate surface 13, and the upper surface (for example, the second surface 12) is arranged between the arcuate surface 13 and the first surface 11. The second surface 12 and the first surface 11 are arranged parallel to each other, so that the sensing unit 20 has a uniform reflection distance, but there is not limited thereto. Further, the airbag unit 10 may further include a tuyere 14 arranged on one side between the first surface 11 and the second surface 12, so as to allow gas 100 to be inflated into the airbag unit 10, but there is not limited thereto.

In some embodiments, further, the first surface 11 is a PU material layer with a transparency of 100%, the second surface 12 is an orange nylon mixed PU material layer, and the arcuate surface 13 is an indigo blue nylon mixed with PU material layer. In particular, the first surface 11 is for enabling an infrared ray output from the sensing unit 20 to pass through the first surface 11, and enter the airbag unit 10 to achieve an object of distance sensing, but there is not limited thereto.

The sensing unit 20 is arranged on the first surface 11 of the airbag unit 10, and senses a distance data 200 between the first surface 11 and the second surface 12.

In some embodiments, the sensing unit 20 includes a distance sensor that is used to sense the distance data 200, and the distance sensor may include a visible light sensor, an ultrasonic sensor, a laser sensor, an infrared sensor, a far infrared (FIR) sensor, a time of flight (ToF) sensor, a 3D structured light sensor, a Doppler radar, or a rangefinder camera (RF camera, also known as linked rangefinder camera), etc., but there is not limited thereto.

In some embodiments, the sensing unit 20 may include light-emitting diode (LED), and the light-emitting diode may include red light-emitting diode in a visible light range (for example, aluminum gallium arsenide (AlGaAs), arsenide Gallium phosphide (GaAsP), indium gallium aluminum phosphide (AlGaInP), gallium phosphide doped zinc oxide (GaP:ZnO)), orange light-emitting diode (for example, gallium arsenide phosphide (GaAsP), phosphide Indium gallium aluminum phosphide (AlGaInP), gallium phosphide doped X (GaP:X)), yellow light-emitting diode (for example, gallium arsenide phosphide (GaAsP), indium gallium aluminum phosphide (AlGaInP), gallium phosphide doped nitrogen (GaP:N)), green light-emitting diode (for example, indium gallium nitride (InGaN), gallium nitride (GaN), gallium phosphide (GaP), aluminum indium gallium phosphide (AlGaInP), aluminum gallium phosphide (lGaP), blue light-emitting diode (for example, zinc selenide (ZnSe), indium gallium nitride (InGaN), silicon carbide (SiC)), violet light-emitting diode (for example, indium nitride) gallium (InGaN)), and infrared light-emitting diode (for example, gallium arsenide (GaAs), aluminum gallium arsenide (AlGaAs)) or ultraviolet light-emitting diode (for example, diamond, aluminum nitride (AlN), aluminum gallium nitride (AlGaN), aluminum gallium indium nitride (AlGaInN), etc., and the light-emitting diode may also include organic light-emitting diode (OLED), but there is not limited thereto.

In some embodiments, further, the sensing unit 20 may further include a printed circuit board (PCB) made of an FR-4 substrate for carrying chips or dies such as light-emitting diodes, etc. The FR-4 substrate includes at least one of glass fiber, epoxy resin, and BT resin. The BT resin is mainly composed of bismaleimide (BMI) and triazine, and is added with epoxy resins, polyphenylene ether (PPE) or allyl compounds etc. as a thermosetting resin formed as a modified component. There are two most typical substrate materials for the printed circuit board (PCB), namely flexible copper clad laminate (FCCL) and resin coated copper (RCC). It is composed of three main components: copper foil, reinforcement, and epoxy. Since a start of a lead-free process, a fourth item of fillers has been added to the PCB in large quantities to improve a heat resistance or flame resistance of the PCB, but there is not limited thereto. The control unit 30 is connected with the airbag unit 10 and the sensing unit 20, and receives the distance data 200.

In some embodiments, the control unit 30 may include one of a microcontroller (MCU), a microprocessor (MPU), a central processing unit (CPU), an application specific integrated circuit (ASIC), digital signal processor (DSP), graphic processing unit (GPU), field programmable gate array (FPGA), or a system-on-chip (SoC). The MCU may also include a circuit board based on the Arduino machine code architecture, such as a printed circuit board (PCB). The SoC may be a Raspberry Pi and its model number may be Type 1A, Type 1A+, Type 1B, Type 1B+, Type 2B, Type 3B, Type 3B+, Type 3A+, or Type 4B, etc., but there is not limited thereto.

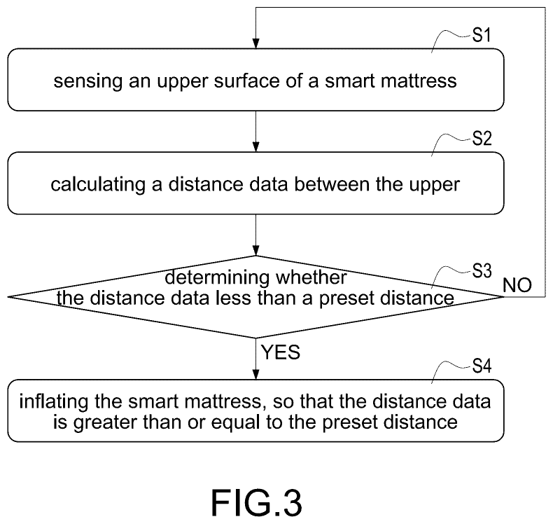

As shown in FIG. 3, a control method of the smart mattress 1 of the present disclosure includes steps S1 to S4.

Please refer to FIG. 1 and FIG. 3, step S1 is to sense the upper surface 11 of the smart mattress 1. In some embodiments, the lower surface may be the first surface 11, and the upper surface may be the second surface 12, but there is not limited thereto. It is worth mentioning that, in the present embodiment, the upper surface is the upper surface for sensing, rather than the uppermost surface (such as the arcuate surface 13 in FIG. 2), but there is not limited thereto.

In the step S1, the sensing unit 20 arranged on the first surface 11 (for example, the lower surface) of the airbag unit 10 used to sense the second surface 12 (for example, the upper surface) of the airbag unit 10 to obtain a distance between the first surface 11 and the second side 12.

The step S2 calculates the distance data 200 between the upper surface 11 and the lower surface 12 of the smart mattress 1. In some embodiments, the control unit 30 is connected to the airbag unit 10 and the sensing unit 20, and receives a sensing data of the sensing unit 20 to calculate the distance data 200. Further, the control unit 30 obtains the distance data 200 by calculating the distance between the first surface 11 and the second surface 12.

The step S3 is to determine whether the distance data 200 is less than a preset distance. If the determination in step S3 is no, return to the step S1, but there is not limited thereto. In other words, if the distance data 200 is not less than the preset distance, the control unit 30 determines that the airbag unit 10 has the gas 100 enough to support the user (not shown) lying on it, then does not inflate the airbag unit 10, and returns to the step S1 to continually monitor the status of the airbag unit 10, but there is not limited thereto.

In some embodiments, the gas 100 may include ordinary atmosphere or inert gases (also known as noble gases), etc. Some properties of the inert gases satisfy the modern theory of atomic structure, the outermost electron shell is full of electrons, that is, it has reached a state of octahedron (also known as an eight-electron rule), so the inert gases are very stable and rarely undergo chemical reactions. Further, the inert gases may include helium (He), neon (Ne), argon (Ar), krypton (Kr), xenon (Xe) or radon (Rn), but there is not limited thereto.

In some embodiments, the preset distance is an optimal distance to avoid an occurrence of bedsores, or other user-set distances. In some embodiments, the preset distance may be pre-stored in a memory (for example, ROM) in the control unit 30, a separate storage unit such as EEPROM, a flash memory (for example, NAND flash or an SSD including a control chip, etc.), or non-volatile storage media such as cloud servers, but there is not limited thereto.

The step S4 is to input the gas 100 to the smart mattress 1 when the distance data 200 is less than the preset distance, so that the distance data is greater than or equal to the preset distance. In other words, if the distance data 200 is smaller than the preset distance, the control unit 30 determines that the gas 100 of the airbag unit 10 is not enough to support the user lying on the airbag unit 10, there is a risk of the user touching the ground and causing the user's bedsores. Therefore, the control unit 30 inflates the airbag unit 10 until the control unit 30 determines that the distance data 200 is greater than or equal to the preset distance, so that the user lying on the airbag unit 10 obtains better support and it reduces the risk of the user touching the ground and causing the user's bedsores.

In summary, the smart mattress 1 of the present disclosure obtains a current inflation state of the airbag unit 10 by sensing the distance between the opposite sides (for example, the upper surface 11 and the lower surface 12) of the airbag unit 10. At this time, the preset distance has been pre-stored before the smart mattress 1 is sold. The control unit 30 is used to determine whether the distance data 200 meets a requirement of the preset distance (for example, it needs to be greater than or equal to the preset distance), so as to determine whether to further inflate the airbag unit 10, or to issue a warning message, such as air leakage or falling out of bed.

In the related-art technology, a barometer is usually used to determine whether to perform an inflation action. However, as to the movement of the user on the air mattress, he seldom lies on or leaves the air mattress at one time with his whole-body surface. When the user's body is partially moving, an air pressure sensing method may not correctly know the user's movements on the air mattress, and may fail to correctly recognize the user's movements. In addition, when the air mattress is partially pressed or released, gas molecules in the air mattress need to propagate to a state with a uniform molecular density before conducting pressure sensing, resulting in poor sensitivity and real-time performance of the air pressure sensing method.

In some embodiments of the present disclosure, the control method of distance sensing clearly recognizes that the user's movements on various local positions of the smart mattress 1 are pressing or releasing. The system uses the control method of distance sensing to infer the user's movements or posture, allowing the control unit 30 to accurately inflate some airbag units 10 (for example, individual control of each airbag unit 10, or differentiation of airbag units in odd and even order, etc.). In addition, the control method of distance sensing of the present disclosure is applied to a change of a distance between the upper surface 11 and the lower surface 12 of the airbag unit 10, so as to avoid a state where the user has touched the ground but does not sense abnormality.

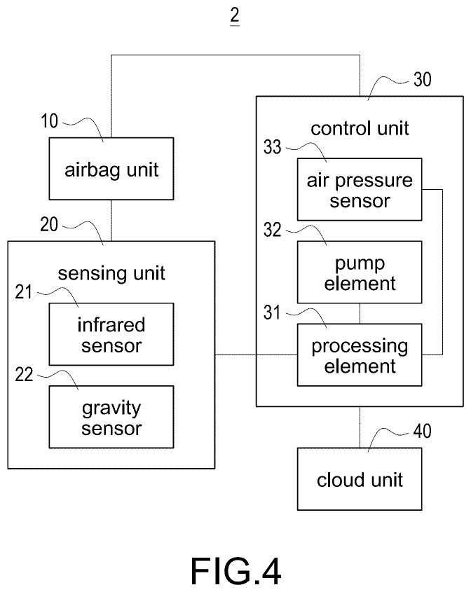

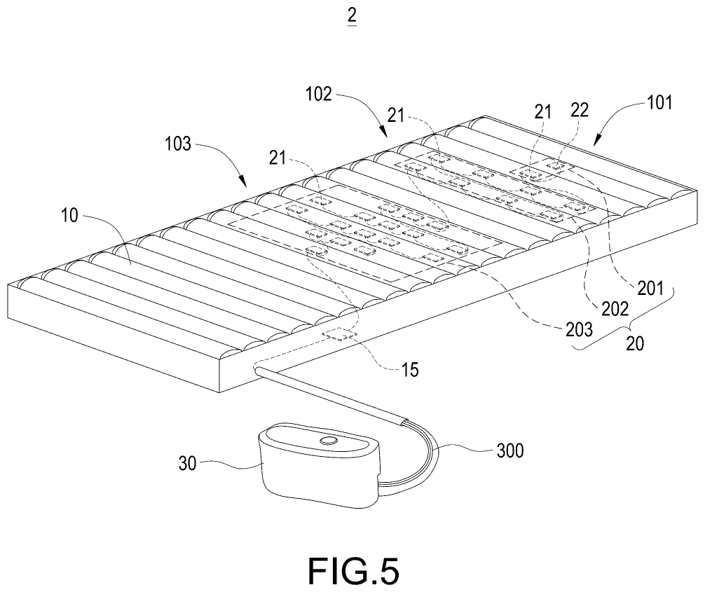

FIG. 4 is a system architecture diagram of a second embodiment of the smart mattress of the present disclosure. FIG. 5 is a schematic structural diagram of a plurality of airbag units of the smart mattress of the present disclosure.

As shown in FIG. 4 and FIG. 5, the smart mattress 2 of the present disclosure is similar to the smart mattress 1 of the first embodiment aforementioned. The differences are that the sensing unit 20 may include an infrared sensor 21 and gravity sensor 22. And the control unit may include a processing element 31, a pump element 32, and an air pressure sensor 33.

In some embodiments, the infrared sensor 21 is electrically connected to the control unit 30, and senses the distance data 200.

In some embodiments, further, the infrared sensor 21 may include a light emitting unit, a receiving unit, a phase measuring unit, a counting display unit, a logic control unit, and a power converter, etc. In some embodiments, the light emitting unit may include a gallium arsenide (GaAs) light emitting diode, and its P-N junction may emit near-infrared light with a wavelength of about 0.72 μm to 0.94 μm. Since electrons in GaAs materials undergo an energy level transition, some excess energy generated by the electrons recombining with holes is released in form of photons to generate near-infrared light, but there is not limited thereto.

In some embodiments, the gravity sensor 22 is electrically connected to the control unit 30, the gravity sensor 22 senses acceleration in multiple directions in a space, and generates angle change data. The control unit 30 outputs a first warning message according to the angle change data.

In some embodiments, further, the gravity sensor 22 may include an accelerometer, which may also be known as an acceleration sensor, a gravimeter (G-sensor), etc., is a device for measuring acceleration. Relative to the remote sensing device, the gravity sensor 22 measures its own motion. When the accelerometer is used to measure gravity (for example, the gravitational acceleration G value caused by center of the earth), it may call the gravimeter. When the accelerometer is applied to microelectromechanical systems (MEMS) or geolocation, it is also known as a global navigation satellite system (GNSS), which receives satellite signals to achieve an object of accurate geolocation. The global navigation satellite system may include the global positioning system (GPS) in United State, assisted global positioning system (AGPS), global navigation satellite system (GLONASS) in Russia, Beidou navigation satellite system (BDS) in mainland China, and Galileo satellite system in European Union, etc., but there is not limited thereto.

In some embodiments, the first warning message may include a warning for falling out of bed, that is, an abnormal angle (for example, an angle is too large or too small) is present, or an angle changing speed is detected to be too fast, etc. The first warning message may output with sound, light intensity, color, flashing, etc., but there is not limited thereto.

In some embodiments, the smart mattress 2 includes a plurality of airbag units 10, and the sensing unit 20 includes a plurality of infrared sensors 21 and a plurality of gravity sensors 22, but there is not limited thereto.

In some embodiments, further, the airbag units 10 are arranged in parallel, and include a first group of airbag units 101, a second group of airbag units 102, and a third group of airbag units 103. The second group of airbag units 102 is adjacent to the first group of airbag units 101. The third group of airbag units 103 is adjacent to the second group of airbag units 102. The second group of airbag units 102 is located between the first group of airbag units 101 and the third group of airbag units 103.

In some embodiments, the first group of airbag units 101 may correspond to the head and neck of the user (not shown) lying on the smart mattress 2. The second group of airbag units 102 may correspond to the shoulders and upper back of the user. The third group of airbag units 103 may correspond to the buttocks and lower back of the user, but there is not limited thereto.

In some embodiments, the infrared sensors 21 and the gravity sensors 22 of the sensing unit 20 are respectively arranged on at least one of the airbag units 10 of the first group of airbag units 101, at least one of the airbag units 10 of the second group of airbag units 102, and at least one of the airbag units 10 of the third group of airbag units 103. Further, the sensing unit 20 includes a first group of sensing units 201, a second group of sensing units 202 and a third group of sensing units 203.

In some embodiments, further, the first group of sensing units 201 are arranged on the lower surface (for example, the first surface 11 in FIG. 2, which is a light-transmitting surface) of the first group of airbag units 101. And, the first group of sensing units 201 includes an infrared sensor 21 (for example, corresponding to the user's neck) and a gravity sensor 22 (for example, corresponding to the user's head), but there is not limited thereto.

In some embodiments, further, the second group of sensing units 202 are arranged on the lower surface (for example, the first surface 11 in FIG. 2, which is a light-transmitting surface) of the second group of airbag units 102. And, the second group of sensing units 202 include a plurality of infrared sensors 21 (for example, arranged in parallel along the shoulders of the user), but there is not limited thereto.

In some embodiments, further, the third group of sensing units 203 are arranged on the lower surface (for example, the first surface 11 in FIG. 2, which is a light-transmitting surface) of the third group of airbag units 103. And, the third group of sensing units 203 include a plurality of infrared sensors 21 (for example, corresponding to the position of the user's buttocks), but there is not limited thereto.

In some embodiments, the processing element 31 is located in the control unit 30, and is electrically connected to the sensing unit 20, and outputs a control signal when the distance data 200 is less than a preset distance.

In some embodiments, the processing element 31 may include one of a microcontroller (MCU), a microprocessor (MPU), a central processing unit (CPU), an application specific integrated circuit (ASIC), digital signal processor (DSP), graphic processing unit (GPU), field programmable gate array (FPGA), or a system-on-chip (SoC). The MCU may also include a circuit board based on the Arduino machine code architecture, such as a printed circuit board (PCB). The SoC may be a Raspberry Pi and its model number may be Type 1A, Type 1A+, Type 1B, Type 1B+, Type 2B, Type 3B, Type 3B+, Type 3A+, or Type 4B, etc., but there is not limited thereto.

In some embodiments, the pump element 32 is located in the control unit 30, and is electrically connected to the processing element 31, and receives the control signal to output the gas 100.

In some embodiments, the pump element 32 may include a gear pump, a screw pump, a plunger pump, a diaphragm pump, etc., but there is not limited thereto.

In some embodiments, the air pressure sensor 33 is connected to the airbag unit 10, and generates an air pressure data. Further, when the control unit 30 determines that the distance data 200 is less than the preset distance, and the air pressure data is less than a preset air pressure, the control unit 30 inflates the airbag unit 10, so that the distance data 200 is greater than or equal to the preset distance, and the air pressure data is greater than or equal to the preset air pressure.

In some embodiments, the air pressure sensor 33 may include a piezoresistive air pressure sensor with a silicon diaphragm, and may be integrated into a microelectromechanical system (MEMS) or an application specific integrated circuit (ASIC) by a specific process, but there is not limited thereto.

In some embodiments, the smart mattress 2 may further include a communication pipe 300, and the control unit 30 may inflate the gas 100 to the airbag units 10 through the communication pipe 300, but there is not limited thereto.

In some embodiments, further, the air pressure sensor 33 may be arranged at one end of the control unit 30 that is connected to the communication pipe 300, and may use to sense an air pressure at one end of the communication pipe 300 to generate the air pressure data. The number of air pressure sensors 33 may be one or more than one, and may be adjusted according to sensitivity or accuracy, but there is not limited thereto. In some embodiments, the control unit 30 outputs a second warning message when a change time of the air pressure data is greater than a preset time.

In some embodiments, the second warning message may include an air leakage warning, that is, it is detected that an inflation time is too long and the air pressure data changes too little or scarcely change. The second warning message may output as sound, light intensity, color, flashing, etc., but there is not limited thereto.

In some embodiments, the control unit 30 may further communicate with a cloud unit 40, and the cloud unit 40 receives the distance data 200 (for example, an infrared data of the infrared sensor 21) to generate a graphical data, but there is not limited thereto.

Further, the communication connection between the control unit 30 and the cloud unit 40 (or other external devices as a command unit, a server, a mobile communication device, etc.) through a wireless protocol, and its hardware connection is achieved by a wireless transceiver antenna and a receiving chip. The wireless protocols may include Bluetooth, radio frequency (RF), near field communication (NFC), infrared (IR), Wi-Fi, LoRa or Zigbee, etc., but there is not limited thereto.

In other embodiments, the communication connection between the control unit 30 and the cloud unit 40 (or other external devices as a command unit, a server, a mobile communication device, etc.) through a wired protocol, and its hardware connection is achieved by USB port, micro-USB port, RJ45 port or serial port. The wired protocol may include at least one of controller area network (CAN or CAN bus), On-Board Diagnostics (OBD and local interconnect network (LIN or LIN bus). Further, a physical line of the ODB may also know as K-line, but there is not limited thereto.

In some embodiments, the mobile communication device may be any electronic device s connectable to an external network, such as a smart phone, a personal digital assistant (PDA), a tablet computer (Pad), a notebook computer (NB), etc., but there is not limited thereto.

In some embodiments, the smart mattress 2 may further include a connection plate 15. The connection board 15 is used for electrical connection with all the sensing units 20 (for example, the sensing units 20 includes the infrared sensors 21 and the gravity sensors 22), and the connection board 15 transfers the distance data 200 obtained by the sensing units 20 through an electric line in the communication pipe 300 to the control unit 30, but there is not limited thereto.

In some embodiments, the control unit 30 respectively controls the airbag units 10 in odd order and the airbag units 10 in even order for a plurality of airbag units 10 arranged in parallel, but there is not limited thereto.

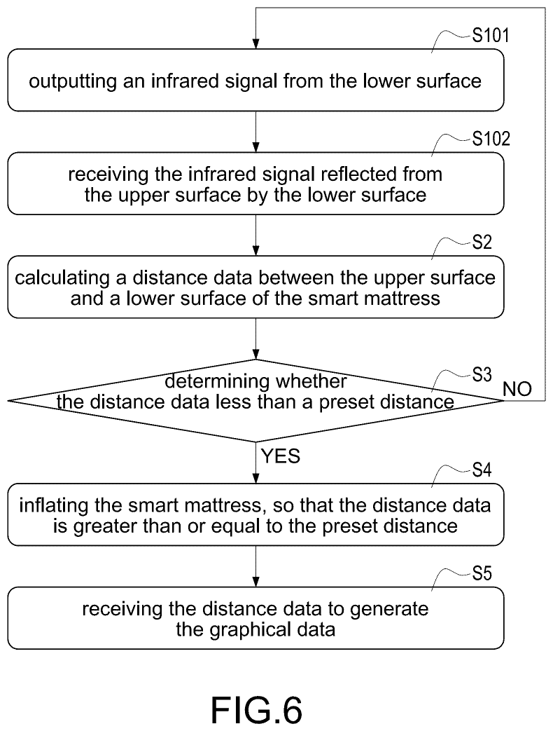

As shown in FIG. 6, the control method of the smart mattress 2 of the present disclosure includes steps S101 to S102, and steps S2 to S11.

Please refer to FIG. 4 and FIG. 6, the step S101 is to output an infrared signal from the lower surface.

In some embodiments, the sensing unit 20 includes the infrared sensor 21, and the infrared sensor 21 outputs infrared signals from the lower surface (for example, the transparent first surface 11), so that the infrared signals in the airbag unit 10 are transported to the upper surface.

The step S102 is to receive the infrared signal reflected from the upper surface by the lower surface.

In some embodiments, after the infrared sensor 21 outputs the infrared signal from the lower surface of the airbag unit 10, the infrared sensor 21 detects the infrared signal reflected from the upper surface (for example, the opaque second surface 12 of FIG. 2), and generates the distance data 200 by an amount of energy of the infrared signal received, but there is not limited thereto.

The step S2 is to calculate the distance data 200 between the upper surface 11 and the lower surface 12 of the smart mattress 2. In some embodiments, the control unit 30 is connected to the airbag unit 10 and the sensing unit 20, and receives a sensing data of the sensing unit 20 to calculate the distance data 200. Further, the control unit 30 obtains the distance data 200 by calculating the distance between the first surface 11 and the second surface 12 (for example, the distance data 200 is obtained by the amount of energy of the infrared signal received).

The step S3 is to determine whether the distance data 200 is less than a preset distance. If the determination in step S3 is no, it returns to the step S101, but there is not limited thereto. In other words, if the distance data 200 is not less than the preset distance, the control unit 30 determines that the airbag unit 10 has the gas 100 enough to support the user (not shown) lying on it, then does not inflate the airbag unit 10, and returns to the step S101 to continuing monitor the status of the airbag unit 10, but there is not limited thereto.

In some embodiments, the preset distance is an optimal distance to avoid an occurrence of bedsores, or other user-set distance. In some embodiments, the preset distance may be pre-stored in a memory (for example, ROM) in the control unit 30, a separate storage unit such as EEPROM, a flash memory (for example, NAND flash or an SSD including a control chip, etc.), or non-volatile storage media such as cloud servers, but there is not limited thereto.

The step S4 is to input the gas 100 to the smart mattress 2 when the distance data 200 is less than the preset distance, so that the distance data is greater than or equal to the preset distance. In other words, if the distance data 200 is smaller than the preset distance, the control unit 30 determines that the gas 100 of the airbag unit 10 is not enough to support the user lying on the airbag unit 10, there is a risk of the user touching the ground and causing the user's bedsores. Therefore, the control unit 30 inflates the airbag unit 10 until the control unit 30 determines that the distance data 200 is greater than or equal to the preset distance, so that the user lying on the airbag unit 10 obtains better support and it reduces the risk of the user touching the ground and causing the user's bedsores.

In some embodiments, the step S4 may further include the following steps: when the distance data 200 is less than the preset distance, the infrared sensor 21 outputs the control signal to the control unit 30, and the control unit 30 receives the control signal to inflate the smart mattress 2, but there is not limited thereto.

In some embodiments, the control method may further include step S5.

The step S5 is after the step S4, the cloud unit 40 generates the graphical data (for example, presenting on a web page and being accessible by a mobile communication device) according to the distance data 200 received by the control unit 30, but there is not limited thereto.

In some embodiments, the mobile communication device may be any electronic device connectable to an external network, such as a smart phone, a personal digital assistant (PDA), a tablet computer (Pad), a notebook computer (NB), etc., but there is not limited thereto.

In some embodiments, further, the authority of the cloud unit 40 to access the web page is limited by user account and passwords, and the authority may be distinguished according to account types (for example, the users are distinguished as manufacturers, doctors, caregivers, family members, patients, etc.), but there is not limited thereto.

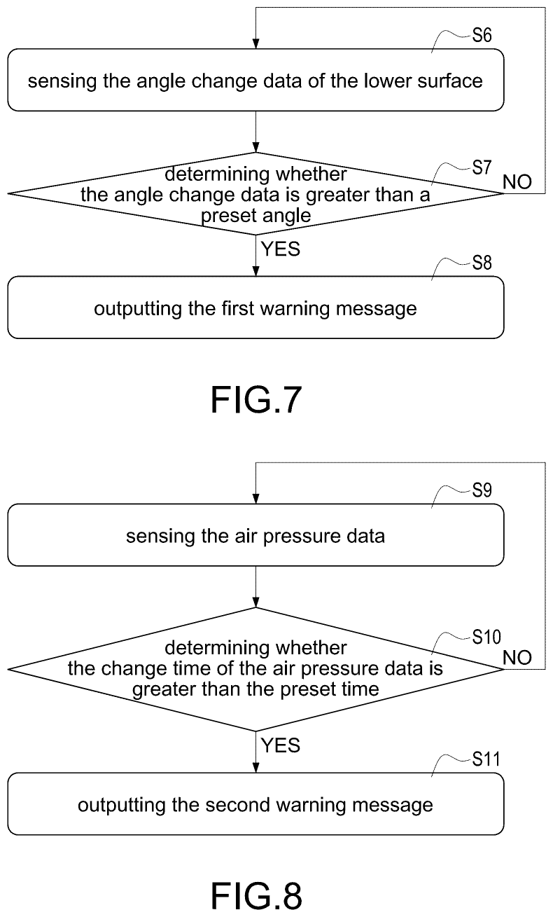

As shown in FIG. 7, the control method of the smart mattress 2 of the present disclosure may further include steps S6 to S8.

Please refer to FIG. 4, FIG. 6, and FIG. 7, in step S6, the sensing unit 20 senses the angle change data of the lower surface.

In some embodiments, the sensing unit 20 includes the gravity sensor 22. The gravity sensor 22 is used to determine whether the user lying on the airbag unit 10 has abnormal movements or postures by sensing the angle change data of the lower surface, but there is not limited thereto.

In step S7, the control unit 30 determines whether the angle change data is greater than a preset angle.

In some embodiments, the control unit 30 determines, according to the angle change data, that the angle change of the user's movements is greater than the preset angle (for example, 30 degrees), and may use an algorithm to assess the risk of falling out of bed, but there is not limited thereto. In other words, if the angle change data detected by the gravity sensor 22 are all normal, the control unit 30 determines that the user lying on the airbag unit 10 has no abnormal movement or posture, and returns to step S6 to sense the angle change data of the lower surface by the gravity sensor 22, but there is not limited thereto.

In step S8, when the angle change of the user's movements is greater than the preset angle, the control unit 30 determines that the user may have an abnormal movement or posture, and outputs the first warning message, but there is not limited thereto.

In some embodiments, the first warning message may include a warning for falling out of bed, that is, an abnormal angle (for example, an angle is too large or too small) is present, or an angle changing speed is detected to be too fast, etc. The first warning message may output as sound, light intensity, color, flashing, etc., but there is not limited thereto.

In some embodiments, after calculating the angle change data with the gravity sensor 22 by an algorithm, the control unit 30 further determines whether the user turns over or leaves the bed, and may count the number of times of turning over, but there is not limited thereto.

As shown in FIG. 8, the control method of the smart mattress 2 of the present disclosure may further include steps S9 to S11.

Please refer to FIG. 4, FIG. 6, and FIG. 8, in step S9, the air pressure sensor 33 senses the air pressure data.

In some embodiments, the control unit 30 includes an air pressure sensor 33, the control unit 30 determines whether the air pressure change in the airbag unit 10 is normal by sensing the air pressure data of the airbag unit 10, but there is not limited thereto. Further, the air pressure sensor 33 may sense the airbag units 10 in odd order first, or sense the airbag units 10 in even order first, but there is not limited thereto.

In step 10, the control unit 30 determines whether the change time of the air pressure data is greater than the pre-set time.

In some embodiments, in addition to detecting a real-time air pressure value of the airbag unit 10 by the air pressure sensor 33, the control unit 30 also determines whether the change in the air pressure data within a preset time is abnormal (for example, inflation time exceeds the preset time but the air pressure data does not change), but there is not limited thereto. In other words, if the air pressure values detected by the air pressure sensor 33 are all normal, the control unit 30 determines that the airbag unit 10 is in a normal state, and returns to the step S9 to continue to detect the real-time air pressure value of the airbag unit 10 by the air pressure sensor 33, but there is not limited thereto.

In step S11, when the change in the air pressure data within the preset time is abnormal (for example, inflation time exceeds the preset time but the air pressure data does not change), the control unit 30 determines that the airbag unit 10 may leak air or the pump element 32 is faulty, etc., and outputs the second warning message, but there is not limited thereto.

The second warning message includes an air leak warning, that is, it is detected that the inflation time is too long and the change in the air pressure data is too small or almost unchanged, and the second warning message may output as sound, light intensity, color, flashing, etc., but there is not limited thereto.

Therefore, the smart mattress 2 of the present disclosure senses the distance data 200 of the airbag unit 10 by the infrared sensor 21, and the smart mattress 2 is also equipped with the gravity sensor 22 to detect whether the user's posture is abnormal (for example, falling off the bed, etc.) to output the first warning message. Further, the smart mattress 2 is equipped with the air pressure sensor 33 to detect whether the airbag unit 10 is abnormal (for example, air leakage, etc.) to output the second warning message, but there is not limited thereto.

In some embodiments, the control unit 30 may also transmit the distance data 200 to the cloud unit 40, so as to process the distance data 200 into the graphical data, and control the access authority of the distance data 200 according to the account and password, but there is not limited thereto.

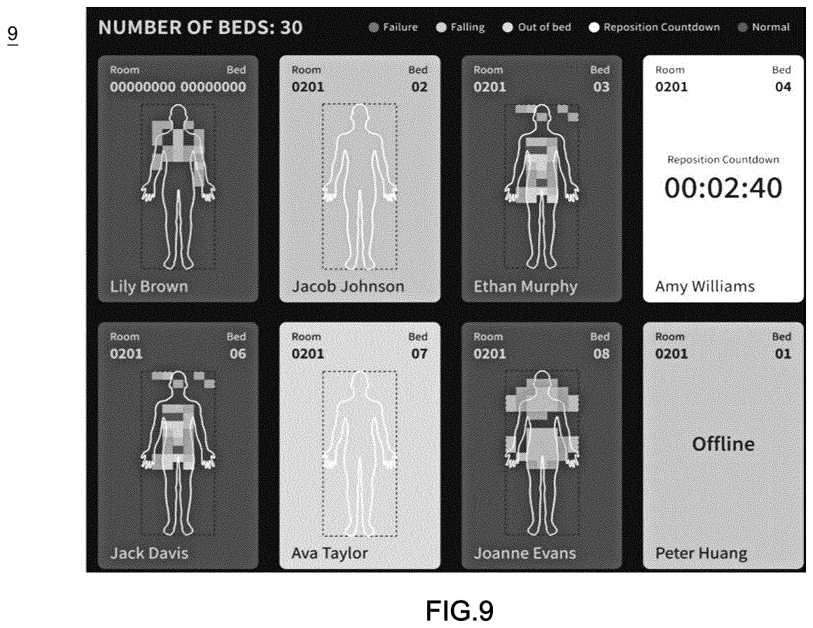

FIG. 9 is a schematic diagram of a graphical data of the smart mattress of the present disclosure.

As shown in FIG. 9, the presentation method of the graphical data is to mark different blocks on the virtual human body image, and distinguish them by different sizes, shapes, colors, etc., so that users may clearly understand the status of different users on the smart mattress 1, 2 and the status of various parts of each user, but there is not limited thereto.

In summary, the smart mattress of the present disclosure obtains a current inflation state of the airbag unit by sensing the distance between the opposite sides (for example, the upper surface and the lower surface) of the airbag unit. In some embodiments, the sensing unit (for example, infrared sensor) has an ability to output and receive infrared signals. When the sensing unit is arranged on the lower surface, the distance data of the airbag unit is obtained by receiving the infrared signal reflected from the upper surface. At this time, the preset distance that has been pre-stored before the smart mattress is sold. For example, the preset distance is stored in a memory such as ROM in the control unit, independent storage units such as EEPROM, NAND flash, or cloud server, etc., the control unit is used to determine whether the distance data meets a requirement of the preset distance (for example, it needs to be greater than or equal to the preset distance), so as to determine whether to further inflate the airbag unit, or to issue a warning message, such as air leakage or falling out of bed.

In the related-art technology, a barometer is usually used to determine whether to perform an inflation action. However, as to the movement of the user on the air mattress, he seldom lies on or leaves the air mattress at one time with his whole-body surface. When the user's body is partially moving, an air pressure sensing method may not correctly know the user's movements on the air mattress, and may fail to correctly recognize the user's movements. In addition, when the air mattress is partially pressed or released, gas molecules in the air mattress need to propagate to a state with a uniform molecular density before conducting pressure sensing, resulting in poor sensitivity and real-time performance of the air pressure sensing method.

In some embodiments of the present disclosure, the control method of distance sensing clearly recognizes that the user's movements on various local positions on the smart mattress are pressing or releasing. The system uses the control method of distance sensing to infer the user's movements or posture, allowing the control unit to accurately inflate some airbag units (for example, individual control of each airbag unit, or differentiation of airbag units in odd and even order, etc.). In addition, the control method of distance sensing of the present disclosure is applied according to a change of a distance between the upper surface and the lower surface of the airbag unit, so as to avoid a state where the user has touched the ground but it does not sense abnormality.

In some embodiments, the smart mattress of the present disclosure is also equipped with the gravity sensor to detect whether the user's posture is abnormal (for example, falling off the bed, etc.) to output the first warning message. Further, the smart mattress is equipped with the air pressure sensor to detect whether the airbag unit is abnormal (for example, air leakage, etc.) to output the second warning message, but there is not limited thereto.

In some embodiments, the control unit may also transmit the distance data to the cloud unit, so as to process the distance data into the graphical data, and control the access authority of the distance data according to the account and password, but there is not limited thereto.

Therefore, the smart mattress and the control method thereof in the present disclosure, which is instant in sensing human movements, has high sensitivity, and may avoid abnormal conditions, so as to improve a user experience and avoid an occurrence of bedsores.

The above is only a detailed description and drawings of the preferred embodiments of the present disclosure, but the features of the present disclosure are not limited thereto, and are not intended to limit the present disclosure. All the scope of the present disclosure shall be subject to the scope of the following claims. The embodiments of the spirit of the present disclosure and its similar variations are intended to be included in the scope of the present disclosure. Any variation or modification that may be easily conceived by those skilled in the art in the field of the present disclosure may be covered by the following claims.

What is claimed is:

1. A smart mattress comprising:
an airbag unit comprising a first surface and a second surface opposite to each other;
a sensing unit arranged on the first surface of the airbag unit, and configured to sense a distance data between the first surface and the second surface; and
a control unit connected with the airbag unit and the sensing unit, and configured to receive the distance data;
wherein, when the control unit determines that the distance data is less than a preset distance, the control unit is configured to inflate the airbag unit, so that the distance data is greater than or equal to the predetermined distance.

2. The smart mattress of claim 1, wherein, the sensing unit comprises:
an infrared sensor electrically connected to the control unit, and configured to sense the distance data; and
a gravity sensor electrically connected to the control unit, and configured to generate an angle change data;
wherein, the control unit is configured to output a first warning message according to the angle change data.

3. The smart mattress of claim 1, wherein, the control unit comprises:
an air pressure sensor connected to the airbag unit, and configured to generate an air pressure data;
wherein, when the control unit determines that the distance data is less than the preset distance and the air pressure data is less than a preset air pressure, the control unit is configured to inflate the airbag unit, so that the distance data is greater than or equal to the preset distance and the air pressure data is greater than or equal to the preset air pressure.

4. The smart mattress of claim 3, wherein, when a change time of the air pressure data is greater than a preset time, the control unit is configured to output a second warning message.

5. The smart mattress of claim 1, wherein, the control unit comprises:
a processing element electrically connected to the sensing unit, and configured to output a control signal when the distance data is less than the preset distance; and
a pump element electrically connected with the processing element, and configured to receive the control signal and to output a gas.

6. The smart mattress of claim 1, wherein, the control unit is connected in communication with a cloud unit, and the cloud unit is configured to receive the distance data to generate a graphical data.

7. A smart mattress comprising:
a plurality of airbag units arranged in parallel at equal distances, each airbag unit comprising an upper surface and a lower surface opposite to each other;
a plurality of infrared sensors respectively arranged on the lower surfaces of at least a part of the airbag units; and
a control unit connected with the airbag units and the infrared sensors;
wherein, the lower surface of each of the airbag units is a light-transmitting surface.

8. The smart mattress of claim 7, wherein, the airbag units comprise:
a first group of airbag units;
a second group of airbag units adjacent to the first group of airbag units; and
a third group of airbag units adjacent to the second group of airbag units, the second group of airbag units located between the first group of airbag units and the third group of airbag units;
wherein, the infrared sensors are respectively arranged on at least one of the airbag units of the first group of airbag units, at least one of the airbag units of the second group of airbag units, and at least one of the airbag units of the third group of airbag units.

9. The smart mattress of claim 7, further comprising:
a gravity sensor arranged on the lower surface of at least one of the airbag units, and electrically connected with the control unit, and configured to generate an angle change data;
wherein, the control unit is configured to output a first warning message according to the angle change data.

10. The smart mattress of claim 7, wherein, the control unit comprises:
an air pressure sensor is connected to the airbag units, and configured to generate an air pressure data;
wherein, when the control unit determines that the air pressure data is less than a preset air pressure, the control unit is configured to inflate the airbag units, so that the air pressure data is greater than or equal to the preset air pressure.

11. The smart mattress of claim 10, wherein, when a change time of the air pressure data is greater than a preset time, the control unit is configured to output a second warning message.

12. The smart mattress of claim 7, wherein, the control unit comprises:
a processing element is electrically connected to the sensing unit; and
a pump element is electrically connected with the processing element, and to inflate the airbag units.

13. The smart mattress of claim 7, wherein, the control unit is connected in communication with a cloud unit, and the cloud unit is configured to receive an infrared data from the infrared sensors to generate a graphical data.

14. A control method for a smart mattress, comprising:
sensing an upper surface of a smart mattress;
calculating a distance data between the upper surface and a lower surface of the smart mattress;
determining whether the distance data less than a preset distance; and
inflating the smart mattress when the distance data less than the preset distance, so that the distance data is greater than or equal to the preset distance.

15. The control method of claim 14, further comprising:
outputting an infrared signal from the lower surface; and
receiving the infrared signal reflected from the upper surface by the lower surface;
wherein, the distance data is obtained by an amount of energy of the infrared signal received.

16. The control method of claim 14, further comprising:
sensing an angle change data of the lower surface;
wherein, the control unit is configured to output a first warning message according to the angle change data.

17. The control method of claim 14, further comprising:
sensing an air pressure data of the smart mattress;
wherein, inflating the smart mattress when the air pressure data is less than a preset air pressure, so that the distance data is greater than or equal to the preset distance, and the air pressure data is greater than or equal to the preset air pressure.

18. The control method of claim 17, further comprising:
outputting a second warning message when a change time of the air pressure data is greater than a preset time.

19. The control method of claim 14, further comprising:
outputting a control signal when the distance data is less than the preset distance; and
receiving the control signal, and inflating the smart mattress.

20. The control method of claim 14, further comprising:
receiving the distance data to generate a graphical data.
